(19) United States
(12) Patent Application Publication
(10) Pub. No.: US 2014/0160340 A1
(43) Pub. Date: Jun. 12, 2014

(54) Methods for Enhancing Perception of Image Quality at Capture Using Gaze Detection and Devices Thereof

(71) Applicants: Susan P. Farnand, Fairport, NY (US); Jeff B. Pelz, Pittsford, NY (US)

(72) Inventors: Susan P. Farnand, Fairport, NY (US); Jeff B. Pelz, Pittsford, NY (US)

(73) Assignee: ROCHESTER INSTITUTE OF TECHNOLOGY, Rochester, NY (US)

(21) Appl. No.: 14/103,551

(22) Filed: Dec. 11, 2013

Related U.S. Application Data
(60) Provisional application No. 61/735,722, filed on Dec. 11, 2012.

(51) Int. Cl. H04N 5/232

(52) U.S. Cl. CPC H04N 5/23219
USPC 348/333.11

(57) ABSTRACT

The method enhances the perceived quality of the main subject matter in an image at capture by determining where in the scene the photographer is looking using gaze-tracking technology. The device includes an image management computing device coupling a processor, memory, input and display device interface, optional network interface device, and camera directed at the photographer as well as the scene.

### CROSS REFERENCE

This application claims the benefit of U.S. Provisional Patent Application Ser. No. 61/735,722, filed Dec. 11, 2012, the contents of which are hereby incorporated by reference in its entirety.

### FIELD

This invention relates to enhancing perception of image quality at capture using gaze detection.

### BACKGROUND

New developments in camera technology allow the determination of where in the scene the photographer is looking. A known tablet has two cameras, one directed at the scene and one directed at the user. The camera directed at the scene is used to take pictures. The other camera is used to determine where the user looks at on the tablet, such as where on the display the user is looking when they search the web. However, these two cameras do not work together to capture an image.

Another known device has two cameras, one directed at the scene and one directed at the user. The user points the device at an image, typically shown on a viewing screen. The device is equipped with eye-tracking technology that collects information on where in the image the user is looking. That information is used to adjust the camera settings, e.g., focus, shutter speed, and aperture opening, to part of the image where the user is looking. However, none of these existing technologies actually process an image at capture. The relevant art lacks a device used to process an image at capture based upon information provided by gaze technology.

### SUMMARY

In accordance with an aspect of the present invention there is provided a method for enhancing the perception of the quality of an image at capture using gaze detection including capturing by an image management computing device an unprocessed image of an object of interest and one or more other objects; determining by the image management computing device the object of interest among the one or more other objects from the captured image using gaze detection; processing by the image management computing device the captured image to enhance the perception of the quality of the determined object of interest; and displaying by the image management computing device the processed image.

In accordance with another aspect of the present invention there is provided a non-transitory computer readable medium having stored thereon instructions for enhancing the perception of the image quality at capture using gaze detection comprising machine executable code which when executed by at least one processor, causes the processor to perform steps including capturing an unprocessed image of an object of interest and one or more other objects; determining the object of interest among the one or more other objects from the captured image using gaze detection; processing the captured image to enhance the perception of the quality of the determined object of interest; and displaying the processed image.

In accordance with another aspect of the present invention there is provided an image management computing device including one or more processors; a memory, wherein the memory coupled to the one or more processors which are configured to execute programmed instructions stored in the memory including capturing by an image management computing device an unprocessed image of an object of interest and one or more other objects; determining by the image management computing device the object of interest among the one or more other objects from the captured image using gaze detection; processing by the image management computing device the captured image to enhance the perception of the quality of the determined object of interest; and displaying by the image management computing device the processed image.

### BRIEF DESCRIPTION OF THE DRAWINGS

FIG. 1 is an exemplary block diagram of an image management computing device in accordance with the present invention;

FIG. 2 is an exemplary flow chart for a method for enhancing the perception of image quality at capture using gaze detection;

FIG. 3 is an illustration of an unprocessed image at capture in accordance with the present invention;

FIG. 4 is an example of an illustration of a processed image at capture in accordance with the present invention;

FIG. 5 is an example of an illustration of another processed image at capture in accordance with the present invention; and

FIG. 6 is an exemplary flow chart for another embodiment of a method for enhancing the perception of image quality at capture using gaze detection.

### DETAILED DESCRIPTION

The present invention is directed to enhancing the perceived quality of an image at capture using gaze detection. The invention utilizes cameras directed at the photographer as well as the scene, such as devices having viewing screens on cameras, that allows by gaze-tracking technology the determination of where in the scene the photographer is looking. This technology is especially useful for people photographing with the cameras embedded on their tablet computers, whose large displays are particularly conducive to gaze detection. These technological developments can be used in accordance with the present invention to determine the object of interest in the captured scene. Image segmentation can be used to further identify and isolate the object of interest.

With the area or object of interest identified, the available information at capture may be processed so as to optimize the perceived image quality for the identified area or object. The optimization of the perceived image quality could include gamut mapping and tonal rendering such that any compromises that must be made occur in areas other than the object of interest. Further, the background and areas other than the object of interest could be processed to increase the saliency of the object of interest. This could include blur or tonal adjustments of background areas. The object of interest could also be processed to increase saliency by adjusting tonal values to increase contrast or saturation.

While this entire process can be automated, through an ‘Enhance Main Subject’ setting, for example, ‘off-ramps’ from the process allowing the photographer control may also be included. For example, the identified object of interest could be outlined or false-colored or otherwise distinguished on the camera view screen at the time of capture so that the photographer could be made aware of the identified area. If the photographer does not agree that the area identified was the main subject matter, he or she would have the option to change it. Similarly, if the photographer did not approve of the image as processed, the camera system would allow the user to revert to the image as taken. Thus, in-camera processing in accordance with the present methods enables the on-board enhancement of images.

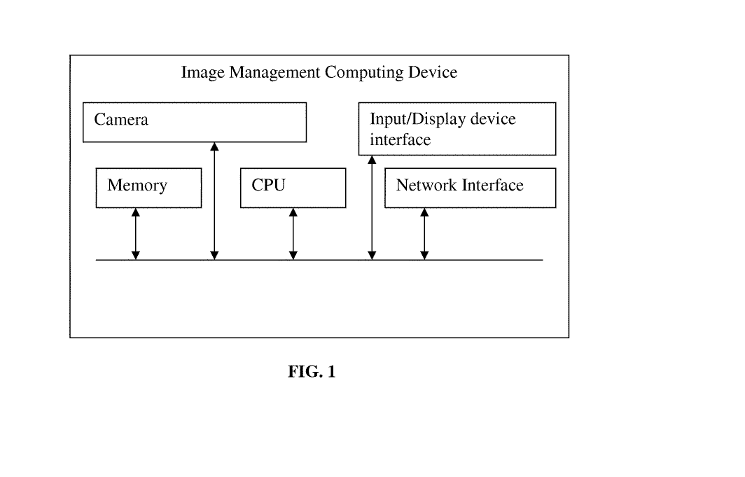

An exemplary block diagram of an image management computing device is illustrated in FIG. 1. The image management computing device provides a number of functions including enhancing the perception of image quality at capture using gaze detection, although additional numbers and types of functions can be performed by the image management computing device.

Referring more specifically to FIG. 1, the image management computing device 10 includes a central processing unit (CPU) or processor 11, a memory 12, input and display device interface 13, an optional network interface device 14 and a camera 15, which are coupled together by a bus or other link 16, although other numbers and types components and elements can be present within the image management computing device. A suitable camera 15 includes any capture device that includes cameras capturing both scene and user information. This could be either still cameras or video cameras.

The processor 11 in the image management computing device 10 executes a program of stored instructions for one or more aspects of the present technology as described and illustrated by way of the examples herein, although other types and numbers of processing devices and logic could be used and the processor could execute other numbers and types of programmed instructions. Additionally, the processor 11 can be used for processing an image captured using the camera 15.

The memory 12 in the image management computing device 10 stores these programmed instructions for one or more aspects of the present technology as described and illustrated herein, although some or all of the programmed instructions could be stored and executed elsewhere. A variety of different types of memory storage devices, such as a random access memory (RAM) or a read only memory (ROM) system or a floppy disk, hard disk, CD ROM, DVD ROM, or a non-volatile memory such as a secure digital card or other non-transitory computer readable medium which is read from and written to by a magnetic, optical, or other reading and writing system that is coupled to the processor in the image management computing device 10, can be used for the memory in the image management computing device 10.

Input and display device interface 13 enable a user, such as a photographer, to interact with the image management computing device 10, such as to select an image, modify an image and/or operate the device 10, by way of example only. Input devices may include a touch screen, liquid crystal display screen, keyboard and/or a computer mouse and display devices may include a computer monitor, or a liquid crystal display, although other types and numbers of input devices and display devices could be used.

The optional network interface device 14 in the image management computing device 10 is used to operatively couple and communicate between the image management computing device 10 and other computing devices which can be coupled together via one or more communication networks, although other types and numbers of communication networks or systems with other types and numbers of connections and configurations can be used. By way of example only, the one or more communication networks can use TCP/IP over Ethernet and industry-standard protocols, including NFS, CIFS, SOAP, XML, LDAP, and SNMP, although other types and numbers of communication networks, such as a direct connection, a local area network, a wide area network, modems and phone lines, e-mail, and wireless communication technology, each having their own communication protocols, can be used.

The camera 15 present within the image management computing device 10 records or can capture images and/or video and store the images directly within the memory 12 of the image management computing device 10, although the captured images and video can be stored at any other memory location. The images and/or video includes both scene and user information of where in the scene the photographer is looking. By way of example only, the camera 15 can include components such as multiple lenses, image sensors, although the camera 15 can include any other components easily identifiable by a person having ordinary skill in the art.

Although examples of the image management computing device 10 are described herein, the image management computing device 10 can be implemented on any suitable computer system or computing device. It is to be understood that the devices and systems of the examples described herein are for exemplary purposes, as many variations of the specific hardware and software used to implement the examples are possible, as will be appreciated by those skilled in the relevant art(s).

Furthermore, each of the devices of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the present technology, which when executed by a processor causes the processor to carry out the steps necessary to implement the methods of the examples, as described and illustrated herein. An exemplary method for enhancing the perception of image quality at capture using gaze detection is herein explained with reference to FIGS. 1-3.

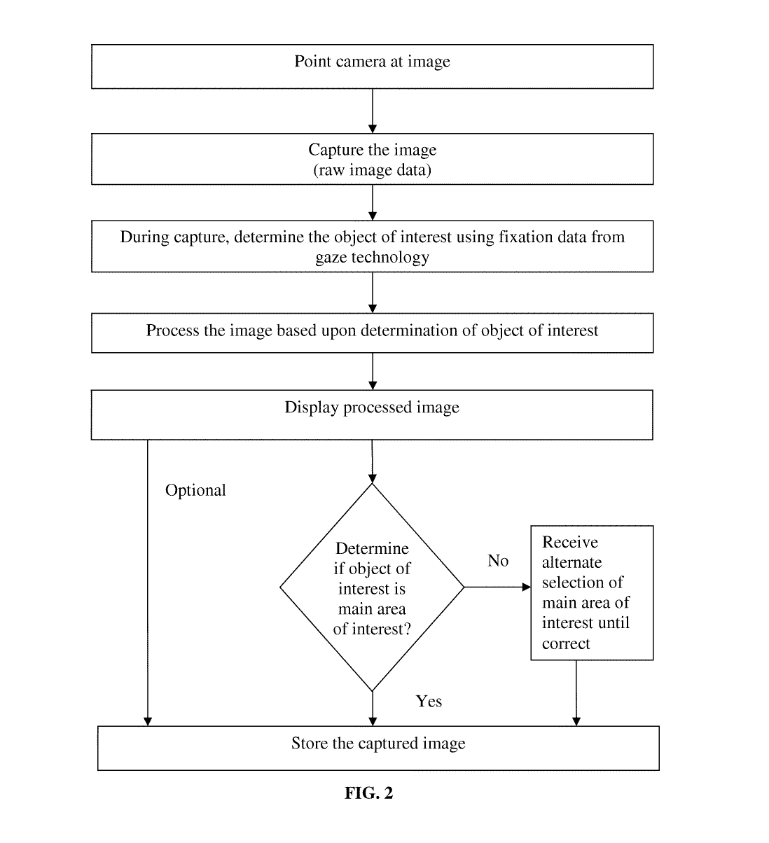

Referring more specifically to FIG. 2, the user of the image management computing device 10 desires to capture an image in an environment by pointing 20 the camera 15 within the image management computing device 10 towards one or more objects in the environment. By way of example only, the objects may include humans, animals, or automobiles, although the objects can include other types of identifiable objects in an environment.

The image management computing device 10 captures 21 the raw image data including an object of interest among one or more other objects in the image. Preferably the raw image data is stored in memory.

Upon collecting the captured image, the image management computing device 10 automatically attempts to determine 22 the object of interest among the one or more other objects in the image based on where the user of the camera is looking when capturing the image as determined using fixation data from gaze detection technology. The gaze-enhanced capture process is initiated by manners known in the art, such as the user pressing a button, or looking at a particular point on the device (looking at a particular point could serve as calibration) to initiate the gaze enhanced capture process. The gaze detection technology monitors the user's fixation points by tracking where the users eye is focused and generates fixation data, including but not limited to length of time at a fixation point, frequency of returning to a fixation point, total time at a fixation point, and the sequence of fixation points while the user prepares to take the photograph. The main interest area may be identified as the area that the user viewed or fixated the longest, the area the user fixated the most times (these metrics are highly correlated when observers view pictorial images and correlate well with the object identified by the observer as the most important content in the image). Other possibilities for identifying the main interest area include the object fixated first, the object fixated last, or some combination of these metrics.

The image management computing device 10 isolates the determined object of interest from the one or more other objects in the captured image using technologies as would be appreciated by a person having ordinary skill in the art, such as image segmentation algorithms and the like. Image segmentation relates to a process of partitioning an image into multiple segments. Another approach would be to simply select the area in a fixed radius around the fixation point. Whether this selection process is used or not, the ‘background area’ could be processed in a Gaussian manner so that the areas near the selection border are minimally affected and the areas farthest from the selection are affected the most. Optionally, the image management computing device can provide an automatic zoom in and zoom out functionality for the isolated object of interest.

Upon determining the object of interest, the image management computing device 10 processes 23 the captured image. The image can be processed by processing the object of interest to enhance the quality of the object of interest of the captured image. The object of interest can be processed modifying the tone, color, saturation, sharpness, light, or contrast to enhance the object of interest, although the image management computing device can enhance the object of interest based on any other parameters, such as zooming in on (enlarging) the object of interest, or the like.

The image can be processed 23 by the image management computing device 10 by processing the raw image data to reduce the size of the captured image, for example, by down sampling the background areas, which could result in saving the memory space and also can be convenient for sharing of the captured image.

The image can be processed 23 by the image management computing device 10 by processing the one or more other objects that are not the object of interest in the image to enhance the perception of the quality of the object of interest of the captured image. By processing the remaining portion of the image other than the object of interest this decreases the distraction which thereby would further increase the perception of the quality of the object of interest. By way of example only, the image management computing device can blur the remaining portion other than the object of interest or modify the tone, saturation, color, light, or contrast of the remaining portion other than the object of interest, which in turn would result in enhancing the perception of the quality of the object of interest.

The image management computing device 10 can process the raw image data by upgrading the area of the image within the object of interest, downgrading the area of the image outside the object of interest, or both. The processing criteria can be selected from the plurality of processing options noted above. Preferably, one or more of these processing options are preselected prior to image capture, by a default setting or the like.

The image management computing device 10 displays 24 the object of interest by techniques known in the art, such as highlighting the object of interest in the segmented image, outlining the object of interest, or false-coloring the object of interest, so that the object of interest can be easily identifiable from the other objects in the image. Although, the image management computing device can use other techniques to make the object of interest easily recognizable from the other one or more objects in the image, such as keeping the selected area and eliminating the non-selected area or zooming in on (enlarging) the selected area.

The image management computing device 10 can determine if the highlighted object is the object of interest in the displayed captured image. In one embodiment, the device is equipped with a gaze enhancement setting that makes the capture process a simple point and shoot with no confirmation of object of interest. In this embodiment, the image management computing device can skip providing a query to the user and automatically store 28 the displayed processed image. In another embodiment, the device provides a query along with multiple options on the input and display interface of the image management computing device 10 for interaction with the user, although the image management computing device can determine if the highlighted object of interest is the desired portion for processing using any other techniques such as detection of faces or high contrast areas in the central area of the frame. Further, the image management computing device receives a selection from the user of one of the options as a response to the query. By way of example only, the query can be “Is the highlighted portion the object of interest?” along with the options of Yes or No on the input and display interface. If the image management computing device receives a selection of Yes as a response to the query, then the image management computing device determines that the highlighted object is the object of interest, the image management computing device proceeds to store 27 the processed captured image.

If the image management computing device 10 receives from the user a No selection in the previous step as a response to the query, then the image management computing device determines that the highlighted object is not the object of interest and receives an alternate selection 26. The image management computing device then attempts to determine if another one of the one or more other objects in the captured image is the object of interest using fixation criteria different from that of the criteria used in the previous selection. The above process is repeated until the object of interest is determined 25.

The image management computing device can store 27 the processed image and display the processed image on the input and display interface 13, although the image management computing device can display the processed image in other ways.

Optionally, the image management computing device may also provide features to further enhance the processed image by displaying the settings such as tone, saturation, color, sharpness, light, or contrast of the processed image on the input and display interface 13 to further enhance the image quality or perception of the image quality of the object of interest. The image management computing device may also provide an expand selection option which enables the user to accept the selected area but also expand it to additional areas in the image. This can be done, for example, by increasing the radius around the fixation point, adding segments as determined by a segmentation algorithm, or in accordance with other ways expressed herein or known to those skilled in the art.

Preferably, at any point in the process, the image management computing device 10 determines if an unprocessed image is required by displaying a query with multiple options on the input and display interface 13 and receives a selection of the options from the user as a response to the query, although the image management computing device can determine if an unprocessed image is required using any other methods or techniques. By way of example only, the displayed query is “Do you want unprocessed image?” along with the options Yes or No. If the image management computing device receives a No selection, then no unprocessed image is displayed.

If in the previous step the image management computing device receives a Yes selection, then the image management computing device retrieves the unprocessed image which is the captured raw image data in the earlier step from the memory and displays the unprocessed image. Optionally, the image management computing device can store the unprocessed image within the memory upon receiving the Yes selection, for any future use.

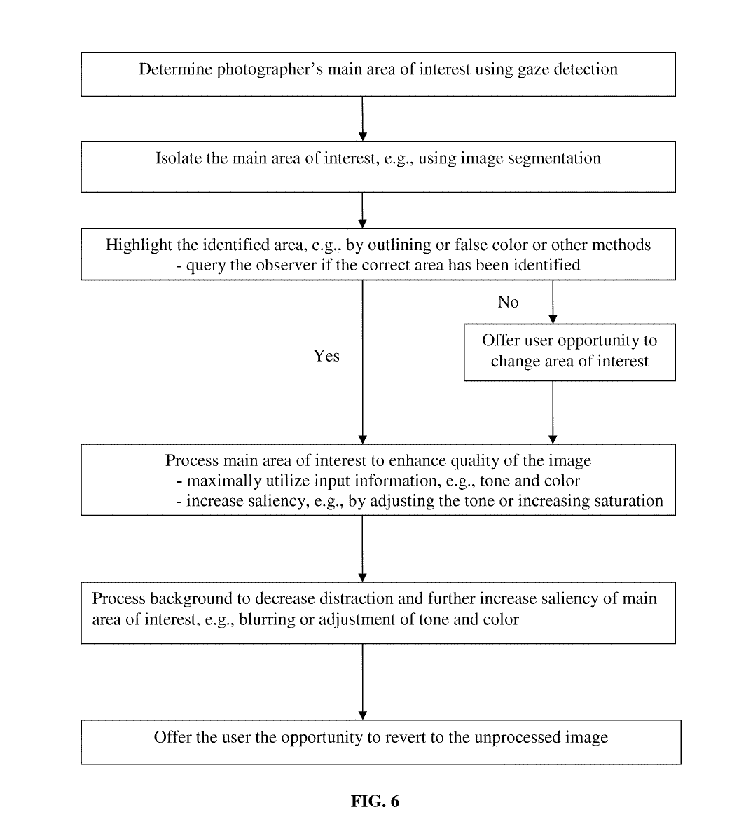

An exemplary method of another embodiment for enhancing the perception of image quality at capture using gaze detection is herein explained with reference to FIG. 6. The user of the image management computing device 10 desires to capture an image in an environment by pointing the camera 15 within the image management computing device 10 towards one or more objects in the environment.

The image management computing device 10 captures the raw image data including an object of interest among one or more other objects in the image and determines 60 the main area of interest using gaze detection. Preferably the raw image data is stored in memory.

The image management computing device 10 isolates 61 the determined object of interest from the one or more other objects in the captured image using technologies as would be appreciated by a person having ordinary skill in the art, such as image segmentation algorithms and the like.

The image management computing device 10 highlights 62 the object of interest in the segmented image by techniques known in the art, such as, outlining the object of interest, or false-coloring the object of interest, so that the object of interest can be easily identifiable from the other objects in the image. The highlighted image is displayed with a query with multiple options on the input and display interface 13 for a selection of the options from the user as a response to the query.

By way of example only, the query can be “Is the highlighted portion the object of interest?” along with the options of Yes or No on the input and display interface. If the image management computing device receives a selection of Yes as a response to the query, then the image management computing device processes the object of the main area of interest to enhance the quality of the image 63, or processes the objects other than the object of the main area of interest to enhance the quality of the image 64, or both.

If the image management computing device 10 receives from the user a No selection in the previous step as a response to the query, then the image management computing device offers 65 the user the opportunity to change the area of interest and receives an alternate selection. The image management computing device then attempts to determine if another one of the one or more other objects in the captured image is the object of interest using fixation criteria different from that of the criteria used in the previous selection. The above process is repeated until the object of interest is determined and then the image is processed by step 63 or step 64, or both.

The image management computing device 10 offers 66 the user the opportunity to revert to the unprocessed image, if desired.

An example of how this technology would be useful is in the context of parents photographing their children at a graduation. At such an event, the photographer may want to capture all or, at least a large number of participants to give an idea of the scope of the event. However, interest typically lies with one particular participant. This technology would allow the user to highlight that participant while still rendering the entire group.

Another example of where this technology would be useful is with light field photography. In such technology, the camera uses an array of micro-lenses to capture information in a way that allows the image to be refocused on different areas of the image after it has been taken, either on the camera itself or virtually on a computer. Known systems currently incorporating this use touch technology to identify the desired area of focus. However, technology disclosed in this application could be used to better identify the object of interest. Gaze detection can be used to refocus on different areas of the same image such as may be desired by different users (for example, different parents want the focus on different children in the same group image) or the same user for different occasions or applications (such as a scientist examining different areas of the same image to answer different questions or different image analysts examining different areas to gain image understanding).

### Example

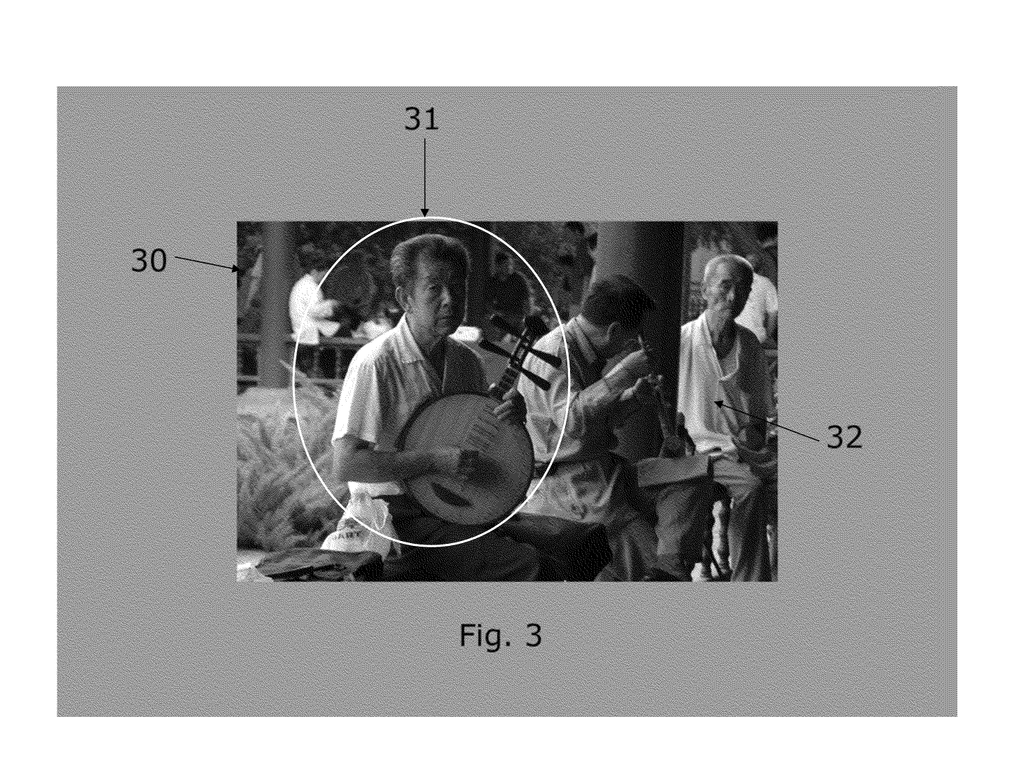

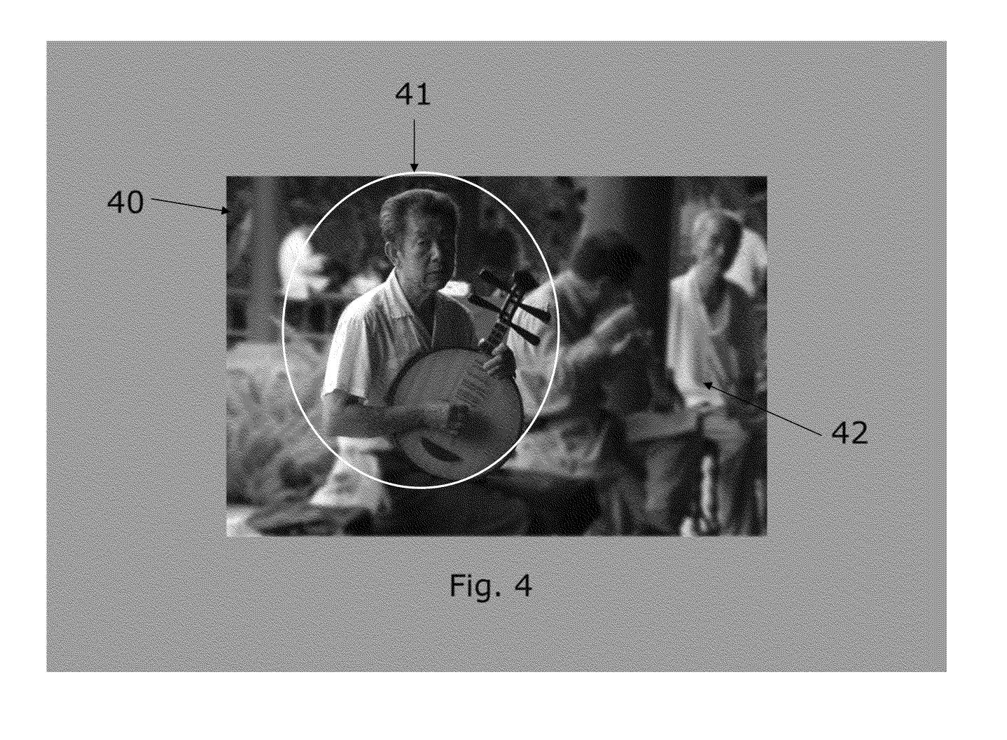

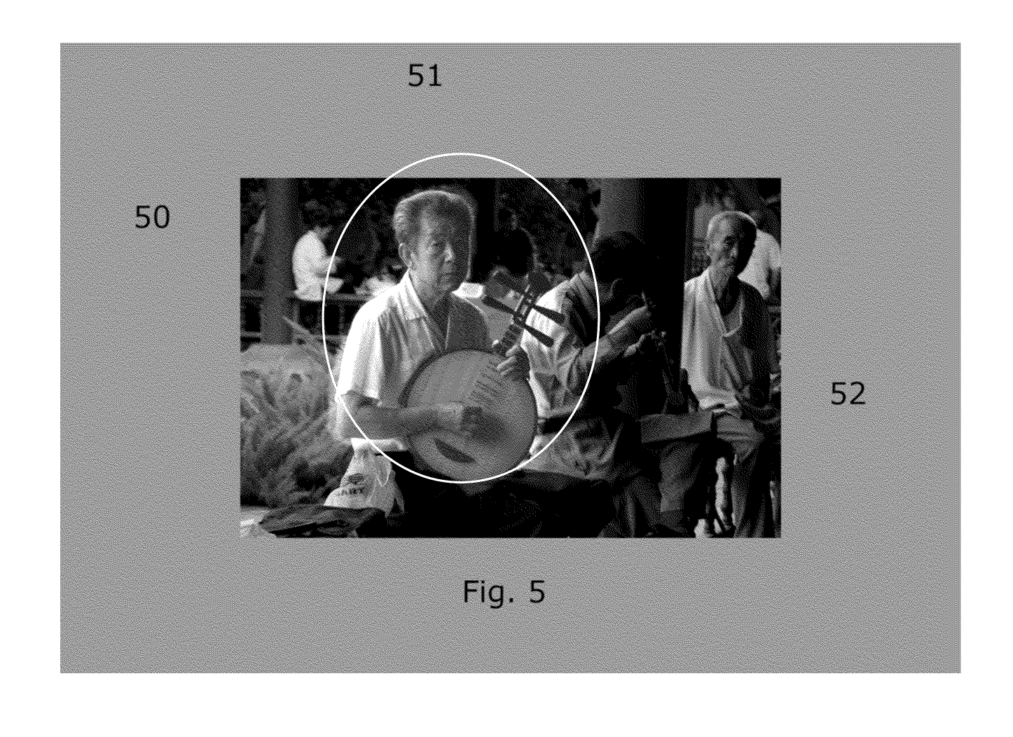

In this prophetic example a user decides to photograph a musician in a group of musicians. The user points the camera at the scene of a group of musicians. The user can initiate the gaze enhanced capture process by looking at a particular point on the device. Once the gaze-enhanced capture process is initiated, the device monitors the user's fixation points and the length of those fixations while the user prepares to take the photograph. The unprocessed image 30 can be captured, as illustrated in FIG. 3, and the fixation data is compiled. The main fixation point can be determined by the longest fixation and the object of interest 31 can be isolated from the remaining objects in the unprocessed image 30 and can be highlighted by image segmentation. The image can then be processed. As illustrated in FIG. 4, the perception of the object of interest 41 in the processed image 40 can be enhanced by de-emphasizing the other objects in the background area 42 by blurring. The processed image 40 can be displayed and the object of interest can be determined. If so, the processed image 40 can be stored. Alternately, the image can be processed in other ways, for example as illustrated in FIG. 5, by modifying the tone of the image by lightening the object of interest 51 and darkening of the other objects in the background area 52 to enhance the perception of the object of interest 51 in the processed image 50. Alternately, the user may chose to revert to the unprocessed image 30.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for enhancing the perception of the quality of an image at capture using gaze detection comprising:
capturing by an image management computing device an unprocessed image of an object of interest and one or more other objects;
determining by the image management computing device the object of interest among the one or more other objects from the captured image using gaze detection;
processing by the image management computing device the captured image to enhance the perception of the quality of the determined object of interest; and
displaying by the image management computing device the processed image.

2. The method as set forth in claim 1 further comprising storing by the image management computing device the unprocessed image of the object of interest.

3. The method as set forth in claim 1 wherein the determining comprises:
isolating by the image management computing device the determined object of interest from the one or more objects using one or more image segmentation techniques;
highlighting by the image management computing device the isolated object of interest using one or more highlighting techniques;
determining by the image management computing device whether the highlighted object of interest is a main area of interest prior to the processing based on one or more fixation criteria.

4. The method as set forth in claim 1 further comprising storing by the image management computing device the processed image of the object of interest.

5. The method as set forth in claim 1 wherein the processing comprises enhancing by the image management computing device the main area of interest in the captured image by modifying one or more image quality parameters of the main area of interest.

6. The method as set forth in claim 1 wherein the processing comprises modifying by the image management computing device a remaining portion of the captured image outside the main area of interest to enhance the perception of the quality of the main area of interest by adjusting the one or more image quality parameters.

7. The method as set forth in claim 1 wherein the determining further comprises receiving by the image management computing device an alternate selection of the main area of interest when the initial determination of the main area of interest is not determined to be object of interest.

8. The method as set forth in claim 1 wherein the processing comprises enhancing by the image management computing device the main area of interest in the captured image by modifying one or more image quality parameters of the main area of interest and modifying by the image management computing device a remaining portion of the captured image outside the main area of interest to enhance the perception of the quality of the main area of interest by adjusting the one or more image quality parameters.

9. A non-transitory computer readable medium having stored thereon instructions for enhancing the perception of the image quality at capture using gaze detection comprising machine executable code which when executed by at least one processor, causes the processor to perform steps comprising:
capturing an unprocessed image of an object of interest and one or more other objects;
determining the object of interest among the one or more other objects from the captured image using gaze detection;
processing the captured image to enhance the perception of the quality of the determined object of interest; and
displaying the processed image.

10. The medium as set forth in claim 9 further comprising storing the unprocessed image of the object of interest.

11. The medium as set forth in claim 9 wherein the determining comprises:
isolating by the image management computing device the determined object of interest from the one or more objects using one or more image segmentation techniques;
highlighting by the image management computing device the isolated object of interest using one or more highlighting techniques;
determining by the image management computing device whether the highlighted object of interest is a main area of interest prior to the processing based on one or more fixation criteria.

12. The medium as set forth in claim 9 further comprising storing by the image management computing device the processed image of the object of interest.

13. The medium as set forth in claim 9 wherein the processing comprises enhancing by the image management computing device the main area of interest in the captured image by modifying one or more image quality parameters of the main area of interest.

14. The medium as set forth in claim 9 wherein the processing comprises modifying by the image management computing device a remaining portion of the captured image outside the main area of interest to enhance the perception of the quality of the main area of interest by adjusting the one or more image quality parameters.

15. The medium as set forth in claim 9 wherein the determining further comprises receiving by the image management computing device an alternate selection of the main area of interest when the initial determination of the main area of interest is not determined to be object of interest.

16. The medium as set forth in claim 9 wherein the processing comprises enhancing by the image management computing device the main area of interest in the captured image by modifying one or more image quality parameters of the main area of interest and modifying by the image management computing device a remaining portion of the captured image outside the main area of interest to enhance the perception of the quality of the main area of interest by adjusting the one or more image quality parameters.

17. An image management computing device comprising:
one or more processors;
a memory, wherein the memory coupled to the one or more processors which are configured to execute programmed instructions stored in the memory comprising:
capturing by an image management computing device an unprocessed image of an object of interest and one or more other objects;
determining by the image management computing device the object of interest among the one or more other objects from the captured image using gaze detection;
processing by the image management computing device the captured image to enhance the perception of the quality of the determined object of interest; and
displaying by the image management computing device the processed image.

18. The device as set forth in claim 17 wherein the one or more processors is further configured to execute programmed instructions stored in the memory further comprising storing by the image management computing device the unprocessed image of the object of interest.

19. The device as set forth in claim 17 wherein the one or more processors is further configured to execute programmed instructions stored in the memory wherein the determining comprises:
isolating by the image management computing device the determined object of interest from the one or more objects using one or more image segmentation techniques;
highlighting by the image management computing device the isolated object of interest using one or more highlighting techniques;
determining by the image management computing device whether the highlighted object of interest is a main area of interest prior to the processing based on one or more fixation criteria.

20. The device as set forth in claim 17 wherein the one or more processors is further configured to execute programmed instructions stored in the memory for determining further comprising storing by the image management computing device the processed image of the object of interest.

21. The device as set forth in claim 17 wherein the one or more processors is further configured to execute programmed instructions stored in the memory for the processing wherein the processing comprises enhancing by the image management computing device the main area of interest in the captured image by modifying one or more image quality parameters of the main area of interest.

22. The device as set forth in claim 17 wherein the one or more processors is further configured to execute programmed instructions stored in the memory for the processing wherein the processing comprises modifying by the image management computing device a remaining portion of the captured image outside the main area of interest to enhance the perception of the quality of the main area of interest by adjusting the one or more image quality parameters.

23. The device as set forth in claim 17 wherein the one or more processors is further configured to execute programmed instructions stored in the memory for the determining wherein the determining further comprises receiving by the image management computing device an alternate selection of the main area of interest when the initial determination of the main area of interest is not determined to be object of interest.

24. The device as set forth in claim 17 wherein the one or more processors is further configured to execute programmed instructions stored in the memory wherein the processing comprises enhancing by the image management computing device the main area of interest in the captured image by modifying one or more image quality parameters of the main area of interest and modifying by the image management computing device a remaining portion of the captured image outside the main area of interest to enhance the perception of the quality of the main area of interest by adjusting the one or more image quality parameters.
